(19) United States
(12) Patent Application Publication
(10) Pub. No.: US 2013/0286053 A1
(43) Pub. Date: Oct. 31, 2013

(54) DIRECT VIEW AUGMENTED REALITY EYEGLASS-TYPE DISPLAY

(71) Applicants: Rod G. Fleck, Bellevue, WA (US); Andreas G. Nowatzyk, San Jose, CA (US); John G. Bennett, Clyde Hill, WA (US)

(72) Inventors: Rod G. Fleck, Bellevue, WA (US); Andreas G. Nowatzyk, San Jose, CA (US); John G. Bennett, Clyde Hill, WA (US)

(21) Appl. No.: 13/720,905

(22) Filed: Dec. 19, 2012

Related U.S. Application Data
(63) Continuation of application No. 13/706,328, filed on Dec. 5, 2012, now abandoned.
Application No. 13/706,328 is a continuation of application No. 13/527,593, filed on Jun. 20, 2012, now abandoned.
Application No. 13/527,593 is a continuation-in-part of application No. 13/455,150, filed on Apr. 25, 2012, now abandoned.

(51) Int. Cl. G09G 5/377; G09G 3/32; G09G 5/10

(52) U.S. Cl. CPC G09G 5/377; G09G 5/10; G09G 3/3208
USPC 345/690; 345/82

(57) ABSTRACT

A low-power, high-resolution, see-through (i.e., “transparent”) augmented reality (AR) display without projectors with relay optics separate from the display surface but instead feature a small size, low power consumption, and/or high quality images (high contrast ratio). The AR display comprises sparse integrated light-emitting diode (iLED) array configurations, transparent drive solutions, and polarizing optics or time multiplexed lenses to combine virtual iLED projection images with a user's real world view. The AR display may also feature full eye-tracking support in order to selectively utilize only the portions of the display(s) that will produce only projection light that will enter the user's eye(s) (based on the position of the user's eyes at any given moment of time) in order to achieve power conservation.

### CROSS-REFERENCE TO RELATED APPLICATIONS

This application is a continuation of pending U.S. patent application Ser. No. 13/706,328, “DIRECT VIEW AUGMENTED REALITY EYEGLASS-TYPE DISPLAY,” filed Dec. 5, 2012, which is a continuation of U.S. patent application Ser. No. 13/527,593, “DIRECT VIEW AUGMENTED REALITY EYEGLASS-TYPE DISPLAY,” filed Jun. 20, 2012, which is a continuation-in-part of U.S. patent application Ser. No. 13/455,150, “HEAD-MOUNTED LIGHT-FIELD DISPLAY,” filed Apr. 25, 2012, the contents of which are hereby incorporated by reference in their entirety.

### BACKGROUND

Augmented reality (AR) is a real-time view of a real world physical environment that is modified by computer-generated sensory input such as video, graphics, and text to enhance the user's perception of that environment. This “augmentation” is generally provided in semantic context with environmental elements—i.e., the text corresponds to something the user sees in the environment—with the help of technological advances in computer vision and object recognition coupled with information about the physical environment itself becoming more and more interactive and digitally manipulable. In many such systems, it is envisioned that “artificial information” about the environment and its objects would be overlaid on the user's real world view. Much research has been undertaken to explore the analysis of computer-generated imagery in live-video streams to provide the inputs used to enhance the perception of the real world for the user.

Typical AR technologies are implemented as head-mounted displays (HMDs) (including some virtual retinal displays (VRDs)) for visualization purposes. These HMDs typically feature one or more projectors with relay optics separate from the display surface (hereinafter referred to as a projector-plus-optic-plus-display or simply a POD) to cover the field of view of the user. A typical POD features a curved display screen that effectively surrounds the user's field of view from all angles, and this curved display is generally paired with one or more projectors plus optics located above, below, or beside each eye (of the user) to produce a stereoscopic view for the user on the curved display(s). However, typical AR solutions are unable to provide a low-power, high-resolution, see-through display without the need for projectors and complex relay optics which often reduces the light efficiency significantly.

### SUMMARY

Various implementations disclosed herein are directed to a low-power, high-resolution, see-through (a.k.a., “transparent”) AR display without a separate projector and relay optics and thus feature a relatively smaller size, low power consumption, and/or high quality images (high contrast ratio). Several such implementations feature sparse integrated light-emitting diode (iLED) array configurations, transparent drive solutions, and polarizing optics or time multiplexed lenses to effectively combine virtual iLED projection images with a user's real world view. In addition, certain such implementations may also feature full eye-tracking support in order to selectively utilize only the portions of the display(s) that will produce only projection light that will enter the user's eye(s) (based on the position of the user's eyes at any given moment of time) in order to achieve power conservation.

Further disclosed herein are various implementations for a transparent AR solution configured to provide a low-power, high-resolution, see-through display resembling a pair of eyeglasses. Several of these various implementations may utilize one or more of the following components: (a) a sparse integrated light-emitting diode (iLED) array featuring a transparent substrate, (b) a random pattern iLED array, (c) a passive array or active transparent array on glass, (d) Dual Brightness Enhancement Film (DBEF) or other polarizing structure on top of the iLED source, (e) a reflecting structure under the iLED array, (f) Quantum Dots (QD) conversion over an iLED array, (g) multi-depositing of iLED material using a lithographic process, (h) global dimming capabilities based on polarized Liquid Crystal (LC) material or opposite direction polarizing material, (i) actively displacing a microlens array, (j) utilization of eye tracking capabilities, and (k) efficiencies for reducing image generation costs.

As used herein, the terms “see-through” and “transparent” denote any material through which at least any portion of the visible light spectrum can pass and be perceived by the human eye. As such, these terms inherently include substances that are fully transparent, partially transparent, substantially transparent, suitably transparent, sufficiently transparent, and so forth, and all such variations (including the foregoing) are deemed equivalent for all purposes.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative implementations, is better understood when read in conjunction with the appended drawings. For the purpose of illustrating the implementations, there is shown in the drawings example constructions of the implementations; however, the implementations are not limited to the specific methods and instrumentalities disclosed. In the drawings:

FIG. 1 is a side-view illustration of an exemplary implementation of a transparent light-field projector (LFP) for a head-mounted light-field display (HMD) comprising an implementation of an augmented reality (AR) system using a microlens array (MLA);

FIG. 2 is a side-view illustration of an implementation of the transparent LFP for a head-mounted light-field display system (HMD) shown in FIG. 1 and featuring multiple primary beams forming a single pixel;

FIG. 3 illustrates how light is processed by the human eye for finite depth cues;

FIG. 4 illustrates an exemplary implementation of the LFP of FIGS. 1 and 2 used to produce the effect of a light source emanating from a finite distance;

FIG. 5 is a side-view illustration of an exemplary implementation of a transparent light-field projector (LFP) for a head-mounted light-field display (HMD) comprising an alternative implementation of an augmented reality (AR) system using a micro-mirror array (MMA);

FIG. 6 is a side-view illustration of an implementation of the transparent LFP for a head-mounted light-field display system (HMD) shown in FIG. 5 and featuring multiple primary beams forming a single pixel;

FIG. 7 illustrates how light is processed by the human eye for finite depth cues (similar to FIG. 3);

FIG. 8 illustrates an exemplary implementation of the LFP of FIGS. 5 and 6 used to produce the effect of a light source emanating from a finite distance;

FIG. 9 illustrates an exemplary SLEA geometry for certain implementations disclosed herein;

FIG. 10 is a block diagram of an implementation of a display processor that may be utilized by the various implementations described herein;

FIG. 11 is an operational flow diagram for utilization of a LFP by the display processor of FIG. 10 in a head-mounted light-field display device (HMD) representative of various implementations described herein;

FIG. 12 is an operational flow diagram for multiplexing of a LFP by the display processor of FIG. 10;

FIG. 13 is a block diagram of a stack structure for a low-power, high-resolution, see-through display representative of one MLA-based implementation of the AR solution using an HMD architecture resembling a pair of eyeglasses disclosed herein;

FIG. 14 is a block diagram of a stack structure for a low-power, high-resolution, see-through display representative of one MMA-based implementation of the AR solution using an HMD architecture resembling a pair of eyeglasses disclosed herein; and

FIG. 15 is a block diagram of an example computing environment that may be used in conjunction with example implementations and aspects.

### DETAILED DESCRIPTION

Displays capable of generating depth cues (such as occlusion, parallax, focus, etc.) are useful for many purposes including vision research, operation of remote devices, medical imaging, surgical training, scientific visualization, and virtual prototyping, and many other virtual- and augmented-reality applications by rendering a faithful impression of the 3D structure of the portrayed object. Ideally, a three-dimensional (3D) capable display system could reproduce the electromagnetic wave-front that enters the eye's pupil from an arbitrary scene across the visible spectrum. This is the operating principle of holographic displays that can reproduce such a wavefront. Holographic displays are currently beyond the reach of practical technology. A light-field display is an approximation to a holographic display that omits the phase information of the wavefront and renders a scene as a two-dimensional (2D) collection of light emitting points, each of which have emission direction dependent intensity (4D+color). At the other end of the display capability spectrum are devices that can only show a single, common image to both eyes, which are commonly termed two-dimensional (2D) capable display systems. There are numerous phenomena such as various forms of parallax, occlusion, focus, color, contrast, etc. cues that may or may not be reproducible by a display system. The display systems described herein belong to a new class of high-end of 3D capable systems that can reproduce a light-field which includes providing correct focus cues over its working depth-of-field (DOF).

For AR applications, typical HMDs feature one or more projectors with relay optics that sit next to the glasses (as opposed to integrating these components into the mostly transparent view surface to cover the field of view of the user by either projecting an image (using LEDs or lasers) on an at-least-partially reflective surface or by generating light guides to form holographic refractive images. However, POD-based HMD systems are heavy, bulky, and power-hungry, and are geometrically constrained in size/shape.

Various implementations disclosed herein are directed to AR solutions utilizing an HMD comprising one or more interactive head-mounted eyepieces with (1) an integrated processor for rendering content for display, (2) an integrated image source (i.e., projector) for displaying the content to an optical assembly through which the user views a surrounding environment along with the displayed content, and (3) an optical assembly through which a user views the surrounding environment and displayed content. Several such implementations may feature an optical assembly that includes an electrochromic layer to provide display characteristic adjustments that are dependent on the requirements of the displayed content coupled with the surrounding environmental conditions. To achieve a large field of view without magnification components or relay optics, display devices are placed close to the user's eyes. For example, a 20 mm display device positioned 15 mm in front of each eye could provide a stereoscopic field of view of approximately 66 degrees.

Several of the various implementations disclosed herein may be specifically configured to provide a low-power, high-resolution, see-through display for an AR solution using an HMD architecture resembling a pair of eyeglasses. These various implementations provide a relatively large field of view (e.g., 66 degrees) featuring high resolution and correct optical focus cues that enable the user's eyes to focus on the displayed objects as if those objects are located at the intended distance from the user. Several such implementations feature lightweight designs that are compact in size, exhibit high light efficiency, use low power consumption, and feature low inherent device costs. Certain implementations may also be preformed or may actively adapt to correct for the imperfect vision (e.g., myopia, astigmatism, etc.) of the user.

For several alternative implementations, the eyepiece may include a see-through correction lens comprising or attached to an interior or exterior surface of the optical waveguide that enables proper viewing of the surrounding environment whether there is displayed content or not. Such a see-through correction lens may be a prescription lens customized to the user's corrective eyeglass prescription or a virtualization of same. Moreover, the see-through correction lens may be polarized and may attach to the optical waveguide and/or a frame of the eyepiece, wherein the polarized correction lens blocks oppositely polarized light reflected from the user's eye. The see-through correction lens may also attach to the optical waveguide and/or a frame of the eyepiece, wherein the correction lens protects the optical waveguide, and may comprise a ballistic material and/or an ANSI-certified polycarbonate material.

In addition, certain implementations disclosed herein are directed to an interactive head-mounted system that includes an eyepiece for wearing by a user and an optical assembly mounted on the eyepiece through which the user views a surrounding environment and a displayed content, wherein the optical assembly comprises a corrective element that corrects the user's view of the environment, an integrated processor for handling content for display to the user, an integrated image source for introducing the content to the optical assembly, and an electrically adjustable lens integrated with the optical assembly that adjusts a focus of the displayed content for the user.

Various implementations disclosed herein feature a head-mounted light-field display system (HMD) that renders an enhanced stereoscopic light-field to each eye of a user. The HMD may include two light-field projectors (LFPs), one per eye, each comprising a transparent solid-state iLED emitter array (SLEA) operatively coupled to a microlens array (MLA) and positioned in front of each eye. For the SLEA, these various implementations may also feature sparse iLED array configurations, transparent drive solutions, and polarizing optics or time multiplexed lenses (such as liquid crystal (LC) or a switchable Bragg grating (SBG)) to more effectively combine virtual LED projection images with a user's real world view. The SLEA and the MLA are positioned so that light emitted from an LED of the SLEA reaches the eye through at most one microlens from the MLA. Several such implementations feature an HMD LFP comprising a moveable SLEA coupled to a microlens array for close placement in front of an eye—without the use of any additional relay or coupling optics—wherein the SLEA physically moves with respect to the MLA to multiplex the iLED emitters of the SLEA to achieve desired resolution.

Various implementations are also directed to “mechanically multiplexing” a much smaller (and more practical) number of LEDs (or, more specifically, iLEDs)—approximately 250,000 total, for example—to time sequentially produce the effect of a dense 177 million LED array. Mechanical multiplexing may be achieved by moving the relative position of the LED light emitters with respect to the microlens array and increases the effective resolution of the display device without increasing the number of LEDs by effectively utilizing each LED to produce multiple pixels comprising the resultant display image. Hexagonal sampling may also increase and maximize the spatial resolution of 2D optical image devices.

It should also be noted that alternative implementations may instead utilize an electro-optical means of multiplexing without mechanical movement. This may be accomplished via liquid crystal material and an electrode configuration that is used to both control the focusing properties of the microlens array as well as allow for controlled asymmetry with respect to the x and y in-plane directions to facilitate the angular multiplexing. In any event, as used herein the term “multiplexing” broadly refers to any one of these various methodologies.

For the various implementations disclosed herein, the HMD may comprise two light-field projectors (LFPs), one for each eye. Each LFP in turn may comprise an SLEA and a MLA, the latter comprising a plurality of microlenses having a uniform diameter (e.g., approximately 1 mm). The SLEA comprises a plurality of solid state integrated light emitting diodes (iLEDs) that are integrated onto a silicon based chip having the logic and circuitry used to drive the LEDs. The SLEA is operatively coupled to the MLA such that the distance between the SLEA and the MLA is equal to the focal length of the microlenses comprising the MLA. This enables light rays emitted from a specific point on the surface of the SLEA (corresponding to an LED) to be focused into a “collimated” (or ray-parallel) beam as it passes through the MLA. Thus, light from one specific point source will result in one collimated beam that will enter the eye, the collimated beam having a diameter approximately equal to the diameter of the microlens through which it passed.

To provide sufficient transparency (also referred to herein as “partial-transparency” and such items are said to be “transparent” if they have any transparent qualities with regard to light in the visible spectrum), certain implementations use a sparse iLED array configured to use one-tenth or less of the active area by utilizing a transparent substrate such as silicon on sapphire (SOS) or single crystal silicon carbide (SCSC). Moreover, certain implementations may utilize a random pattern arrangement for the small spacing offsets between iLEDs in the iLED array in order to avoid undesirable grating artifacts and light fringing. Some implementations may utilize a passive array (having an open or back bias on select lines) while other implementations may use an active transparent array comprising, for example, oxide thin-film transistor (OTFT) structures that are sufficiently transparent. While OTFT structures may have both cost and transparency advantages, other common structures may also be utilized provided that the aperture area is small enough to allow acceptable see-through operation around any non-transparent structures.

In addition, the light emission aperture can be designed to be relatively small compared to the pixel pitch which, in contrast to other display arrays, allows the integration of substantially more logic and support circuitry per pixel. With the increased logic and support circuitry, the solid-state LEDs of the SLEA (comprising the iLEDs) may be used for fast image generation (including, for certain implementations, fast frameless image generation) based on the measured head attitude of the HMD user in order to reduce and minimize latency between physical head motion and the generated display image. Minimized latency, in turn, reduces the onset of motion sickness and other negative side-effects of HMDs when used, for example, in virtual or augmented reality applications. In addition, focus cues consistent with the stereoscopic depth cues inherent to computer-generated 3D images may also be added directly to the generated light field. It should be noted that solid state LEDs can be driven very fast, setting them apart from OLED and LCOS based HMDs. Moreover, while DPL-based HMDs can also be very fast, they are relatively expensive and thus solid-state LEDs present a more economical option for such implementations.

It should be noted that while various implementations described herein utilize iLED technology due to high-speed and high-brightness afforded by this technology, there are a number of alternatives that could also be utilized including but not limited to organic light-emitting diode (OLED) technology currently used for virtual reality (VR) applications. In addition, technologies pertaining to quantum light-emitting diode (QLED) arrays—commonly referred to as “Quantum Dot” (QD) arrays—might also be utilized, and scanning laser or scanning matrix laser solutions using QD arrays are also possible.

Again, common to the various implementations disclosed herein is the elimination of PODs in the head-mounted display (HMD) coupled with the additional benefit of reduced overall power consumption resulting from the constraining of light emissions to only those points where needed (thereby and avoiding illumination, projection, and light guide losses). Certain such implementations may also feature increased resolution, finer focus adjustment, and improved color gamut based on broader improvements described herein to the head-mounted display. The elimination of the PODs in these various implementations permit the development of eyeglass- and sunglass-like products featuring lower weight, smaller size, and reduced loss of peripheral view compared to typical AR solutions, as well as provide better peripheral views and reduce eye strain.

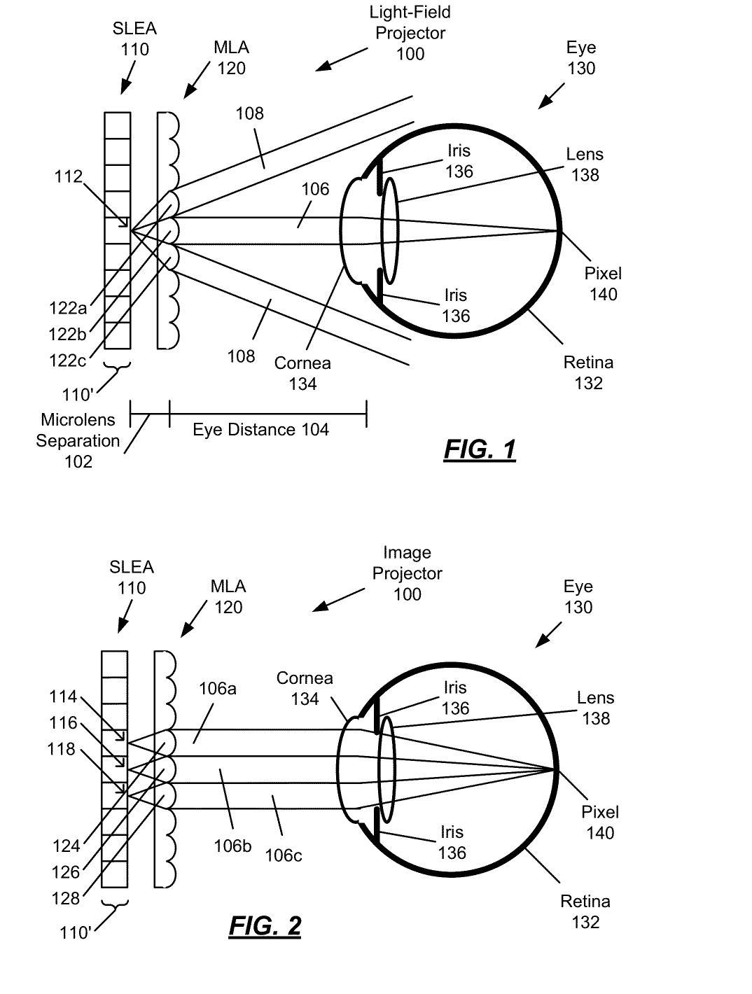

FIG. 1 is a side-view illustration of an exemplary implementation of a transparent light-field projector (LFP) 100 for a head-mounted light-field display (HMD) comprising an implementation of an augmented reality (AR) system. In the figure, an LFP 100 is at a set eye distance 104 away from the eye 130 of the user. The LFP 100 comprises a solid-state LED emitter array (SLEA) 110 and a microlens array (MLA) 120 operatively coupled such that the distance between the SLEA and the MLA (referred to as the microlens separation 102) is equal to the focal length of the microlenses comprising the MLA (which, in turn, produce collimated beams). The SLEA 110 comprises a plurality of solid state light emitting diodes (LEDs), such as LED 112 for example, that are integrated onto a transparent substrate 110′ having the logic and circuitry needed to drive the LEDs. Similarly, the MLA 120 comprises a plurality of microlenses, such as microlenses 122a, 122b, and 122c for example, having a uniform diameter (e.g., approximately 1 mm). It should be noted that the particular components and features shown in FIG. 1 are not shown to scale with respect to one another. It should be noted that, for various implementations disclosed herein, the number of LEDs (that is, iLEDs) comprising the SLEA is one or more orders of magnitude greater than the number of lenses comprising the MLA, although only specific LEDs may be emitting at any given time.

The plurality of LEDs (e.g., LED 112) of the SLEA 110 represents the smallest light emission unit that may be activated independently. For example, each of the LEDs in the SLEA 110 may be independently controlled and set to output light at a particular intensity at a specific time. While only a certain number of LEDs comprising the SLEA 110 are shown in FIG. 1, this is for illustrative purposes only, and any number of LEDs may be supported by the SLEA 110 within the constraints afforded by the current state of technology (discussed later herein). In addition, because FIG. 1 represents a side-view of a LFP 100, additional columns of LEDs in the SLEA 110 are not visible in FIG. 1.

For various implementations disclosed herein, the SLEA 110 comprises a sparse array (order of 10% or less) of iLED array components that are placed on transparent substrate, such as glass, sapphire, silicon-carbite, or similar materials either driven actively (via transparent transistors) or passively (via transparent select lines from the top or the side). Certain of these implementations may use a transparent material like silver nanowires or other thin wires that preserve much of the substrate's overall transparency.

Similarly, the MLA 120 may comprise a plurality of microlenses, including microlenses 122a, 122b, and 122c. While the MLA 120 shown comprises a certain number of microlenses, this is also for illustrative purposes only, and any number of microlenses may be used in the MLA 120 within the constraints afforded by the current state of technology (discussed further herein). In addition, as described above, because FIG. 1 is a side-view of the LFP 100 there may be additional columns of microlenses in the MLA 120 that are not visible in FIG. 1. Further, the microlenses of the MLA 120 may be packed or arranged in a hexagonal or rectangular array (including a square array).

In operation, each LED of the SLEA 110, such as LED 112, may emit light from an emission point of the LED 112 and diverge toward the MLA 120. As these light emissions pass through certain microlenses, such as microlens 122b for example, the light emission for this microlens 122b is collimated and directed toward to the eye 130, specifically, toward the aperture of the eye defined by the inner edge of the iris 136. As such, the portion of the light emission 106 collimated by the microlens 122b enters the eye 130 at the cornea 134, passes between the edges of the iris 136, and is further focused by the lens 138 to be converged into a single point or pixel 140 on the retina 132 at the back of the eye 130. On the other hand, as the light emissions from the LED 112 pass through certain other microlenses, such as microlens 122a and 122c for example, the light emission for these microlens 122a and 122c is collimated and directed away from the eye 130, specifically, away from the aperture of the eye defined by the inner edge of the iris 136. As such, the portion of the light emission 108 collimated by the microlens 122a and 122c does not enter the eye 130 and thus is not perceived by the eye 130. It should also be noted that the focal point for the collimated beam 106 that enters the eye is perceived to emit from an infinite distance. Furthermore, light beams that enter the eye from the MLA 120, such as light beam 106, is a “primary beam,” and light beams that do not enter the eye from the MLA 120 are “secondary beams.”

Since LEDs (including iLEDs) emit light in all directions, light from each LED may illuminate multiple microlenses in the MLA. However, for each individual LED, the light passing through only one of these microlens is directed into the eye (through the entrance aperture of the eye's pupil) while the light passing through other microlenses is directed away from the eye (outside the entrance aperture of the eye's pupil). The light that is directed into the eye is referred to herein as a primary beam while the light directed away from the eye is referred to herein as a secondary beam. The pitch and focal length of the plurality of microlenses comprising the microlens array are used to achieve this effect. For example, if the distance between the eye and the MLA (the eye distance 104) is set to be 15 mm, the MLA would need lenses about 1 mm in diameter and having a focal length of 2.5 mm. Otherwise, secondary beams might be directed into the eye and produce a “ghost image” displaced from but mimicking the intended image.

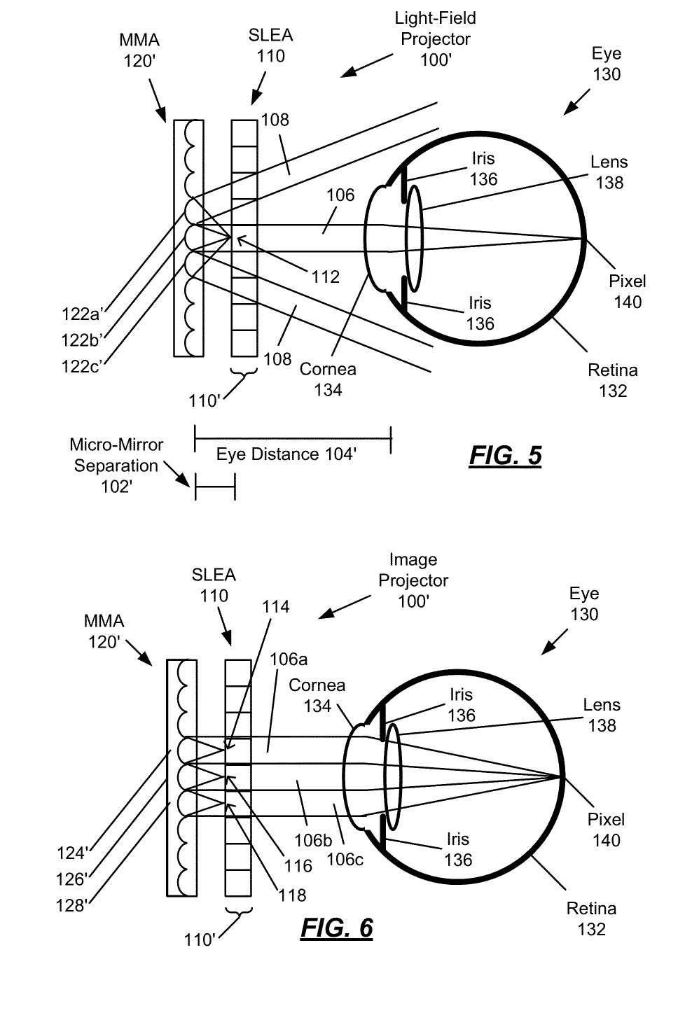

The AR approaches featured by various implementations described herein may comprise the use of an MLA that distorts only the virtual iLED light generated by the display while permitting an undistorted view through the display. To achieve this effect, three distinct mechanisms may be utilized by the MLA: time-domain multiplexing, wavelength multiplexing, and polarization multiplexing. These three approaches use refractive microlenses (as shown in FIG. 1 as well as in FIG. 2 described below) that are switched out of the optical path for direct viewing. Alternatively, AR operation can also be achieved by reversing the iLED emitters so that the generated light is directed away from the eye as shown in FIGS. 5-8 which are described in detail later herein.

For time-domain multiplexing, the MLA is fabricated to behave like a typical microlens array at certain times and like a transparent plane at other times. For example, patterned electro-optical materials like poled Lithium-Niobate might be used for this purpose and, in conjunction with an electro-optical shutter that blocks external light, such a display would be able to alternate between being transparent and opaque while the iLED display projects a rapid succession of images into the eye.

For wavelength multiplexing, the microlens array is also fabricated to only affect a very narrow range of wavelengths to which the iLED array is specifically tuned. In other words, the SLEA might be designed to only emit light in a limited range of the visible spectrum while the corresponding MLA only distorts light in the same limited range of the visible spectrum but does not distort light that is not in this limited range of the visible spectrum. For example, a relatively thick volume holographic element using a material with a low scattering coefficient could be used to implement a 3D Bragg structure to form a microlens array that selectively affects light of three narrow spectral bands, one for each of the primary colors, while all light outside of these three narrow bands would not be diffracted to provide a substantially unchanged view through the display.

For polarization multiplexing, the light from the iLEDs may be polarized perpendicular to the light that passes through the display. Such a microlens array could also be constructed from a birefringent material where the polarization is reflected and focused while the perpendicular polarization passes through unaffected. While polarization multiplexing might be beneficial in certain applications, it is not required and various alternative implementations are contemplated that would not utilize polarization. Conversely, similar effects may be achieved using other dimming materials such as electro-chromic materials, blue-phase liquid crystals (LCs), and polymer dispersed liquid crystals (PDLCs) without polarizers. Moreover, techniques that use dual brightness enhancement film (DBEF) with LEDs (or any other non-polarized emitter) may also include selective rotation of one polarized domain mixed with a 90-degree offset domain for more efficient structure than using DBEF alone.

As will be known and appreciated by skilled artisans, there are many options for constructing microlens arrays utilizing these three mechanisms. It should be noted, however, that the microlens structure will be very large in comparison to the iLED pixel spacing in order to allow variable deflection over the array of iLED pixels per microlens array element.

FIG. 2 is a side-view illustration of an implementation of the transparent LFP 100 for a head-mounted light-field display system (HMD) shown in FIG. 1 and featuring multiple primary beams 106a, 106b, and 106c forming a single pixel 140. As shown in FIG. 2, light beams 106a, 106b, and 106c are emitted from the surface of the SLEA 110 at points respectively corresponding to three individual LEDs 114, 116, and 118 comprising the SLEA 110. As shown, the emission point of the LEDs comprising the SLEA 110—including the three LEDs 114, 116, and 118—are separated from one another by a distance equal to the diameter of each microlens, that is, the lens-to-lens distance (the “microlens array pitch” or simply “pitch”).

Since the LEDs in the SLEA 110 have the same pitch (or spacing) as the plurality of microlenses comprising the MLA 120, the primary beams passing through the MLA 120 are parallel to each other. Thus, when the eye is focused towards infinity, the light from the three emitters converges (via the eye's lens) onto a single spot on the retina and is thus perceived by the user as a single pixel located at an infinite distance. Since the pupil diameter of the eye varies according to lighting conditions but is generally in the range of 3 mm to 9 mm, the light from multiple (e.g., ranging from about 7 to 81) individual LEDs can be combined to produce the one pixel 140.

As illustrated in FIGS. 1 and 2, the MLA 120 may be positioned in front of the SLEA 110, and the distance between the SLEA 110 and the MLA 120 is referred to as the microlens separation 102. The microlens separation 102 may be chosen such that light emitting from each of the LEDs comprising the SLEA 110 passes through each of the microlenses of the MLA 120. The microlenses of the MLA 120 may be arranged such that light emitted from each individual LED of the SLEA 110 is viewable by the eye 130 through only one of the microlenses of the MLA 120. While light from individual LEDs in the SLEA 110 may pass through each of the microlenses in the MLA 120, the light from a particular LED (such as LED 112 or 116) may only be visible to the eye 130 through at most one microlens (122b and 126 respectively).

For example, as illustrated in FIG. 2, a light beam 106b emitted from a first LED 116 is viewable through the microlens 126 by the eye 130 at the eye distance 104. Similarly, light 106a from a second LED 114 is viewable through the microlens 124 at the eye 130 at the eye distance 104, and light 106c from a third LED 118 is viewable through the microlens 128 at the eye 130 at the eye distance 104. While light from the LEDs 114, 116, and 118 passes through the other microlenses in the MLA 120 (not shown), only the light 106a, 106b, and 106c from LEDs 114, 116, and 118 that pass through the microlenses 114, 116, and 118 are visible to the eye 130.

For various AR implementations described herein, real world light may need to be polarized in an opposite direction to the virtual LED emitted light. Therefore, certain HMD implementations disclosed herein might also incorporate global or local pixel based opacity to reduce virtual light levels. For the several implementations that may utilize liquid crystal (LC) material and thus use polarizing films, at least half of the real world light will be lost and/or absorbed before it can pass through to the virtual light generation plane.

For certain implementations, a Dual Brightness Enhancement Film (DBEF) or other polarizing structure may be used on top of the iLED array to obtain a single polarized direction from the virtual display source and provide some recycling of opposite polarized light from the iLED array. DBEF is a reflective polarizer film that reflects light of the “wrong” polarization instead of absorbing it, and the polarization of some of this reflected light is also randomized into the “right” light that can then pass through the DBEF film which, by some estimates, can make the display approximately one-third brighter than displays without DBEF. Thus DBEF increases the amount of light available for illuminating displays by recycling light that would normally be absorbed by the rear polarizer of the display panel, thereby increasing efficiency while maintaining viewing angle. In addition, certain implementations may also make use of a reflecting structure under iLED elements to increase light recycling, while some implementations may use side walls to avoid cross talk and further improve recycling efficiency.

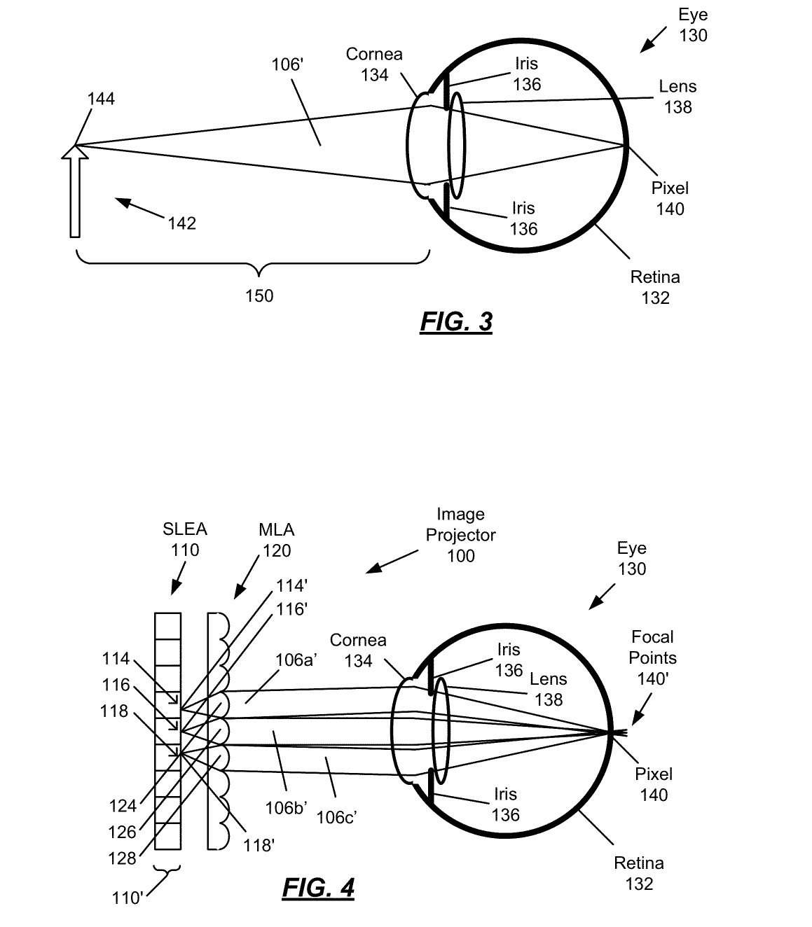

In the implementations described in FIGS. 1 and 2, the collimated primary beams (e.g., 106a, 106b, and 106c) together paint a pixel on the retina of the eye 130 of the user that is perceived by that user as emanating from an infinite distance. However, finite depth cues are used to provide a more consistent and comprehensive 3D image. FIG. 3 illustrates how light is processed by the human eye 130 for finite depth cues, and FIG. 4 illustrates an exemplary implementation of the LFP 100 of FIGS. 1 and 2 used to produce the effect of a light source emanating from a finite distance.

As shown in FIG. 3, light 106′ that is emitted from the tip (or “point”) 144 of an object 142 at a specific distance 150 from the eye will have a certain divergence (as shown) as it enters the pupil of the eye 130. When the eye 130 is properly focused for the object's 142 distance 150 from the eye 130, the light from that one point 144 of the object 142 will then be converged onto a single image point 140 (or pixel corresponding to a photo-receptor in one or more cone-cells) 140 on the retina 132. This “proper focus” provides the user with depth cues used to judge the distance 150 to the object 142.

In order to approximate this effect, and as illustrated in FIG. 4, a LFP 100 produces a wavefront of light with a similar divergence at the pupil of the eye 130. This is accomplished by selecting the LED emission points 114′, 116′, and 118′ such that distances between these points are smaller than the MLA pitch (as opposed to equal to the MLA pitch in FIGS. 1 and 2 for a pixel at infinite distance). When the distances between these LED emission points 114′, 116′, and 118′ are smaller than the MLA pitch, the resulting primary beams 106a′, 106b′, and 106c′ are still individually collimated but are no longer parallel to each other; rather they diverge (as shown) to meet in one point (or pixel) 140 on the retina 132 given the focus state of the eye 130 for the corresponding finite distance depth cue. Each individual beam 114′, 116′, and 118′ is still collimated because the display chip to MLA distance has not changed. The net result is a focused image that appears to originate from an object at the specific distance 150 rather than infinity. It should be noted, however, that while the light 106a′, 106b′, and 106c′ from the three individual MLA lenses 124, 126, and 128 (that is, the center of each individual beam) intersect at a single point 140 on the retina, the light from each of the three individual MLA lenses do not individually converge in focus on the retina because the SLEA to MLA distance has not changed. Instead, the focal points 140′ for each individual beam lie beyond the retina.

As mentioned earlier herein, alternative implementations of the AR operation may also be achieved by reversing the iLED emitters so that the generated light is emitted away from the eye as shown, wherein a partially reflective micro-mirror array (MMA) may then be used to both reflect and focus the light from the iLED emitters into collimated beams directed back toward the eye. As such, any references to or characterizations of the various implementations using an MLA also apply to the various implementations using an MMA and vice versa except where these implementations may be explicitly distinguished. Moreover, in a general sense, the term “micro-array” (MA) can be used to refer to either or both a MLA and/or an MMA.

Similar to FIG. 1, FIG. 5 is a side-view illustration of an exemplary implementation of a transparent light-field projector (LFP) for a head-mounted light-field display (HMD) comprising an alternative implementation of an augmented reality (AR) system using a micro-mirror array (MMA) 120′. In the figure, a LFP 100′ comprises a MMA 120′ that is at a set eye distance 104′ away from the eye 130 of the user. The LFP 100′ further comprises a solid-state LED emitter array (SLEA) 110 operatively coupled to the MMA 120′ such that the distance between the SLEA and the MMA (referred to as the micro-mirror separation 102′) is equal to the focal length of the micro-mirrors comprising the MMA (which, in turn, produce collimated beams). The SLEA 110 comprises a plurality of solid state light emitting diodes (LEDs), such as LED 112 for example, that are integrated onto a transparent substrate 110′ having the logic and circuitry used to drive the LEDs.

Similarly, the MMA 120′ comprises a plurality of micro-mirrors, such as micro-mirrors 122a′, 122b′, and 122c′ for example, having a uniform diameter (e.g., approximately 1 mm). The MMA 120′ is embedded in a planar sheet of optically clear material (for example, poly carbonate polymer or “PC”) and may be partially reflective, or a micro-mirror array may use a dichroic, multilayer coating that preferentially reflects the light in the specific emission bands of the iLED array while permitting other light to pass through unaffected.

It should be noted that the particular components and features shown in FIG. 5 are not shown to scale with respect to one another. It should also be noted that, for various implementations disclosed herein, the number of LEDs (that is, iLEDs) comprising the SLEA is one or more orders of magnitude greater than the number of mirrors comprising the MMA, although only specific LEDs may be emitting at any given time.

The plurality of LEDs (e.g., LED 112) of the SLEA 110 represents the smallest light emission unit that may be activated independently. For example, each of the LEDs in the SLEA 110 may be independently controlled and set to output light at a particular intensity at a specific time. While only a certain number of LEDs comprising the SLEA 110 are shown in FIG. 5, this is for illustrative purposes only, and any number of LEDs may be supported by the SLEA 110 within the constraints afforded by the current state of technology (discussed further herein). In addition, because FIG. 5 represents a side-view of a LFP 100′, additional columns of LEDs in the SLEA 110 are not visible in FIG. 5.

For various implementations disclosed herein, the SLEA 110 comprises a sparse array (order of 10% or less) of iLED array components that are placed on a transparent substrate, such as glass, sapphire, silicon-carbite, or similar materials either driven actively (via transparent transistors) or passively (via transparent select lines from the top or the side). Certain of these implementations may use a transparent material like silver nanowires or other thin wires that preserve much of the substrate's overall transparency.

Similarly, the MMA 120′ may comprise a plurality of micro-mirrors, including micro-mirrors 122a′, 122b′, and 122c′. While the MMA 120′ shown comprises a certain number of micro-mirrors, this is also for illustrative purposes only, and any number of micro-mirrors may be used in the MMA 120′ within the constraints afforded by the current state of technology (discussed further herein). In addition, as described above, because FIG. 5 is a side-view of the LFP 100′ there may be additional columns of micro-mirrors in the MMA 120′ that are not visible in FIG. 5. Further, the micro-mirrors of the MMA 120′ may be packed or arranged in a hexagonal or rectangular array (including a square array).

In operation, each LED of the SLEA 110, such as LED 112, may emit light from an emission point of the LED 112 and diverge toward the MMA 120′. As these light emissions are reflected by certain micro-mirrors, such as micro-mirror 122b′ for example, the light emission for this micro-mirror 122b′ is collimated and directed back through the substantially transparent SLEA 110 toward to the eye 130, specifically, toward the aperture of the eye defined by the inner edge of the iris 136. As such, the portion of the light emission 106 collimated by the micro-mirror 122b′ enters the eye 130 at the cornea 134, passes between the edges of the iris 136, and is further focused by the mirror 138 to be converged into a single point or pixel 140 on the retina 132 at the back of the eye 130. On the other hand, as the light emissions from the LED 112 are reflected by certain other micro-mirrors, such as micro-mirror 122a′ and 122c′ for example, the light emission for these micro-mirror 122a′ and 122c′ is collimated and directed away from the eye 130, specifically, away from the aperture of the eye defined by the inner edge of the iris 136. As such, the portion of the light emission 108 collimated by the micro-mirror 122a′ and 122c′ does not enter the eye 130 and thus is not perceived by the eye 130. It should also be noted that the focal point for the collimated beam 106 that enters the eye is perceived to emit from an infinite distance. Furthermore, light beams that enter the eye from the MMA 120′, such as light beam 106, is a “primary beam,” and light beams that do not enter the eye from the MMA 120′ are “secondary beams.”

Since LEDs (including iLEDs) emit light in all directions, light from each LED may illuminate multiple micro-mirrors in the MMA. However, for each individual LED, the light reflected from only one of these micro-mirrors is directed into the eye (through the entrance aperture of the eye's pupil) while the light passing reflected from other micro-mirrors is directed away from the eye (outside the entrance aperture of the eye's pupil). The light that is reflected into the eye is referred to herein as a primary beam while the light reflected away from the eye is referred to herein as a secondary beam. The pitch and focal length of the plurality of micro-mirrors comprising the micro-mirror array are used to achieve this effect. For example, if the distance between the eye and the MMA (the eye distance 104′) is set to be 15 mm, the MMA would need mirrors about 1 mm in diameter and having a focal length of 2.5 mm. Otherwise, secondary beams might be directed into the eye and produce a “ghost image” displaced from but mimicking the intended image.

The AR approaches featured by various implementations described herein may comprise the use of an MMA that reflects and distorts only the virtual iLED light generated by the display while permitting an undistorted view through the display. To achieve this effect, three distinct mechanisms may again be utilized by the MMA: time-domain multiplexing, wavelength multiplexing, and polarization multiplexing. These three approaches use convex micro-mirrors (as shown in FIG. 5 as well as in FIG. 6 described below) that are switched out of the optical path for direct viewing.

For time-domain multiplexing, the MMA is fabricated to behave like a typical micro-mirror array at certain times and like a transparent plane at other times. For example, patterned electro-optical materials like poled Lithium-Niobate might be used for this purpose and, in conjunction with an electro-optical shutter that blocks external light, such a display would be able to alternate between being transparent and opaque while the iLED display projects a rapid succession of images into the eye.

For wavelength multiplexing, the micro-mirror array is also fabricated to only reflect a very narrow range of wavelengths to which the iLED array is specifically tuned. In other words, the SLEA might be designed to only emit light in a limited range of the visible spectrum while the corresponding MMA only reflects and distorts light in the same limited range of the visible spectrum but does not reflect or distort light that is not in this limited range of the visible spectrum. For example, a relatively thick volume holographic element using a material with a low scattering coefficient could be used to implement a 3D Bragg structure to form a micro-mirror array that selectively reflects light of three narrow spectral bands, one for each of the primary colors, while all light outside of these three narrow bands would not be reflected to provide a substantially unchanged view through the display.

For polarization multiplexing, the light from the iLEDs may be polarized perpendicular to the light that passes through the display. Such a micro-mirror array could also be constructed from a material that reflects light of a certain polarization while the perpendicular polarization passes through unaffected.

As will be known and appreciated by skilled artisans, there are many options for constructing micro-mirror arrays utilizing these three mechanisms. It should be noted, however, that the micro-mirror structure will be very large in comparison to the iLED pixel spacing in order to allow variable deflection over the array of iLED pixels per micro-mirror array element.

Similar to FIG. 2, FIG. 6 is a side-view illustration of an implementation of the transparent LFP 100′ for a head-mounted light-field display system (HMD) shown in FIG. 5 and featuring multiple primary beams 106a, 106b, and 106c forming a single pixel 140. As shown in FIG. 6, light beams 106a, 106b, and 106c are emitted from the surface of the SLEA 110 at points respectively corresponding to three individual LEDs 114, 116, and 118 comprising the SLEA 110. As shown, the emission point of the LEDs comprising the SLEA 110—including the three LEDs 114, 116, and 118—are separated from one another by a distance 102′ equal to the diameter of each micro-mirror, that is, the mirror-to-mirror distance (the “micro-mirror array pitch” or simply “pitch”).

Since the LEDs in the SLEA 110 have the same pitch (or spacing) as the plurality of micro-mirrors comprising the MMA 120′, the primary beams reflected by the MMA 120′ are parallel to each other. Thus, when the eye is focused towards infinity, the light from the three emitters converges (via the eye's cornea 134 and lens 138) onto a single spot on the retina and is thus perceived by the user as a single pixel located at an infinite distance. Since the pupil diameter of the eye varies according to lighting conditions but is generally in the range of 3 mm to 9 mm, the light from multiple (e.g., ranging from about 7 to 81) individual LEDs can be combined to produce the one pixel 140.

As illustrated in FIGS. 5 and 6, the SLEA 110 may be positioned in front of the MMA 120′ (such that the SLEA 110 is between the MMA 120′ and the eye 130), and the distance between the SLEA 110 and the MMA 120′ is referred to as the micro-mirror separation 102′. The micro-mirror separation 102′ may be chosen such that light emitting from each of the LEDs comprising the SLEA 110 is reflected by each of the micro-mirrors of the MMA 120′ back toward the eye 130. The micro-mirrors of the MMA 120′ may be arranged such that light emitted from each individual LED of the SLEA 110 is viewable by the eye 130 via only one of the micro-mirrors of the MMA 120′. While light from individual LEDs in the SLEA 110 may be reflected by each of the micro-mirrors in the MMA 120′, the light from a particular LED (such as LED 112 or 116) may only be visible to the eye 130 from at most one micro-mirror (122b′ and 126 respectively).

For example, as illustrated in FIG. 6, a light beam 106b emitted from a first LED 116 is viewable via reflection from the micro-mirror 126 by the eye 130 at the eye distance 104′. Similarly, light 106a from a second LED 114 is viewable as reflected from the micro-mirror 124 at the eye 130 at the eye distance 104′, and light 106c from a third LED 118 is viewable via the micro-mirror 128 at the eye 130 at the eye distance 104′. While light from the LEDs 114, 116, and 118 are reflected by the other micro-mirrors (not shown) in the MMA 120′, only the light 106a, 106b, and 106c from LEDs 114, 116, and 118 that are reflected by the micro-mirrors 114, 116, and 118 are visible to the eye 130.

For various AR implementations described herein, real world light may need to be polarized in an opposite direction to the virtual LED reflected light. Therefore, certain HMD implementations disclosed herein might also incorporate global or local pixel based opacity to reduce virtual light levels. For the several implementations that may utilize liquid crystal (LC) material and thus use polarizing films, at least half of the real world light will be lost and/or absorbed before it can pass through to the virtual light generation plane.

For certain implementations, a Dual Brightness Enhancement Film (DBEF) or other polarizing structure may be used on top of the iLED array to obtain a single polarized direction from the virtual display source and provide some recycling of opposite polarized light from the iLED array. DBEF is a reflective polarizer film that reflects light of the “wrong” polarization instead of absorbing it, and the polarization of some of this reflected light is also randomized into the “right” light that can then pass through the DBEF film which, by some estimates, can make the display approximately one-third brighter than displays without DBEF. Thus DBEF increases the amount of light available for illuminating displays by recycling light that would normally be absorbed by the rear polarizer of the display panel, thereby increasing efficiency while maintaining viewing angle. In addition, certain implementations may also make use of a reflecting structure under iLED elements to increase light recycling, while some implementations may use side walls to avoid cross talk and further improve recycling efficiency.

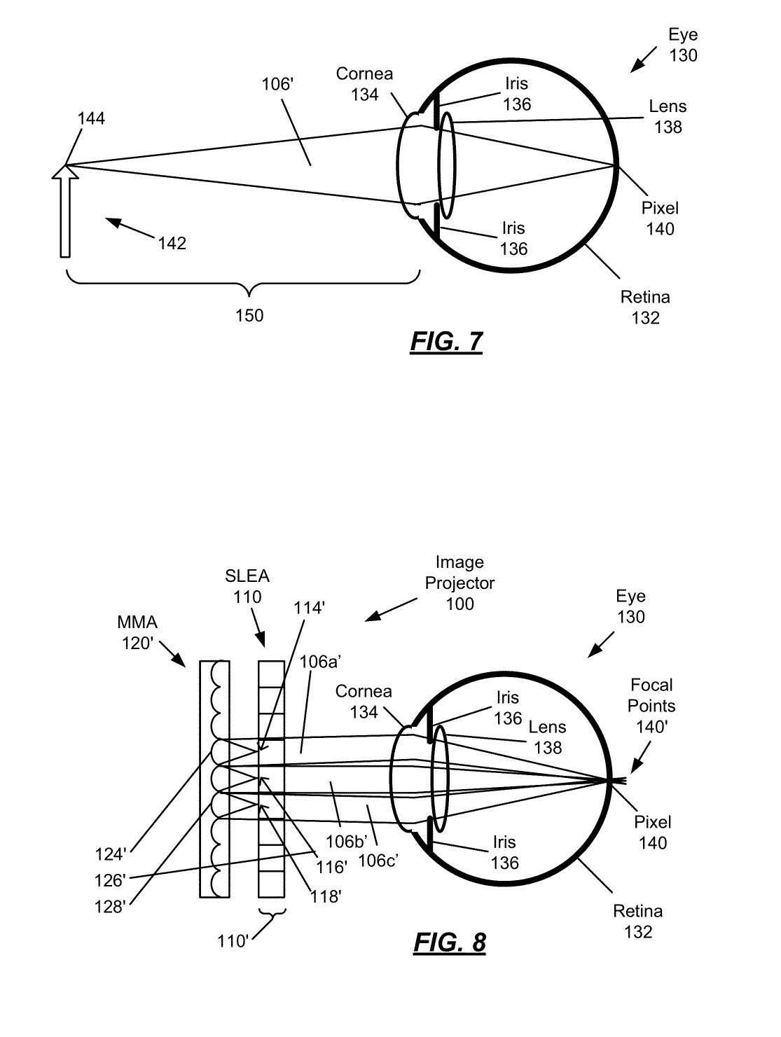

In the implementations described in FIGS. 1 and 2, the collimated primary beams (e.g., 106a, 106b, and 106c) together paint a pixel on the retina of the eye 130 of the user that is perceived by that user as emanating from an infinite distance. However, finite depth cues are used to provide a more consistent and comprehensive 3D image. FIG. 7 illustrates how light is processed by the human eye 130 for finite depth cues, and FIG. 8 illustrates an exemplary implementation of the LFP 100′ of FIGS. 1 and 2 used to produce the effect of a light source emanating from a finite distance.

As shown in FIG. 7 (which is identical to FIG. 3 and replicated here for convenience), light 106′ that is emitted from the tip (or “point”) 144 of an object 142 at a specific distance 150 from the eye will have a certain divergence (as shown) as it enters the pupil of the eye 130. When the eye 130 is properly focused for the object's 142 distance 150 from the eye 130, the light from that one point 144 of the object 142 will then be converged onto a single image point 140 (or pixel corresponding to a photo-receptor in one or more cone-cells) 140 on the retina 132. This “proper focus” provides the user with depth cues used to judge the distance 150 to the object 142.

In order to approximate this effect, and as illustrated in FIG. 8 (which is similar to FIG. 4), a LFP 100′ produces a wavefront of light with a similar divergence at the pupil of the eye 130. This is accomplished by selecting the LED emission points 114′, 116′, and 118′ such that distances between these points are smaller than the MMA pitch (as opposed to equal to the MMA pitch in FIGS. 1 and 2 for a pixel at infinite distance). When the distances between these LED emission points 114′, 116′, and 118′ are smaller than the MMA pitch, the resulting primary beams 106a′, 106b′, and 106c′ are still individually collimated but are no longer reflected parallel to each other by the MMA 120′; rather they diverge (as shown) to meet in one point (or pixel) 140 on the retina 132 given the focus state of the eye 130 for the corresponding finite distance depth cue. Each individual beam 114′, 116′, and 118′ is still collimated because the display chip to MMA distance has not changed. The net result is a focused image that appears to originate from an object at the specific distance 150 rather than infinity. It should be noted, however, that while the light 106a′, 106b′, and 106c′ from the three individual MMA mirrors 124, 126, and 128 (that is, the center of each individual beam) intersect at a single point 140 on the retina, the light from each of the three individual MMA mirrors do not individually converge in focus on the retina because the SLEA to MMA distance has not changed. Instead, the focal points 140′ for each individual beam lie beyond the retina (as shown).

In view of the foregoing, it will be appreciated by skilled artisans that the various MLA implementations and the various MMA implementations are substantially similar in operation. As such, and with particular regard to the following, any references to or characterizations of the various implementations using an MLA, as well as the various features, enhancements, and improvements described thereto, apply with equal force to the various implementations using an MMA (and vice versa). Moreover, in a general sense, the term “micro-array” (MA) can be used to refer to either or both a MLA and/or an MMA.

With regard to both the microlens and micro-mirror implementations herein described and illustrated in FIGS. 1-8, the ability of the HMD to generate focus cues relies on the fact that light from several primary beams are combined in the eye to form one pixel. Consequently, each individual beam contributes only about 1/10 to 1/40 of the pixel intensity, for example. If the eye is focused at a different distance, the light from these several primary beams will spread out and appear blurred. Thus, the practical range for focus depth cues for these implementations uses the difference between the depth of field (DOF) of the human eye using the full pupil and the DOF of the HMD but with the entrance aperture reduced to the diameter of one beam. To illustrate this point, consider the following examples.

First, with an eye pupil diameter of 4 mm and a display angular resolution of 2 arc-minutes, the geometric DOF extends from 11 feet to infinity if the eye is focused on an object at a distance of 22 feet. There is a diffraction-based component to the DOF, but under these conditions, the geometric component will dominate. Conversely, a 1 mm beam would increase the DOF to range from 2.7 feet to infinity. In other words, if the operating range for this display device is set to include infinity at the upper DOF range limit, then the operating range for the disclosed display would begin at about 33 inches in front of the user. Displayed objects that are rendered to appear closer than this distance would begin to appear blurred even if the user properly focuses on them.

Second, the working range of the HMD may be shifted to include a shortened operating range at the expense of limiting the upper operating range. This may be done by slightly decreasing the distance between the SLEA and the MLA (or SLEA and MMA for the various alternative implementations using an MMA). For example, adjusting the MLA focus for a 3 feet mean working distance would produce correct focus cues in the HMD over the range of 23 inch to 6.4 feet. It therefore follows that it is possible to adjust the operating range of the HMD by including a mechanism that can adjust the distance between the SLEA and the MLA so that the operating range can be optimized for the use of the HMD.

The HMD for certain implementations may also adapt to imperfections of the eye 130 of the user. Since the outer surface (cornea 134) of the eye contributes most of the image-forming refraction of the eye's optical system, approximating this surface with piecewise spherical patches (one for each beam of the wavefront display) can correct imperfections such as myopia and astigmatism. In effect, the correction can be translated into the appropriate surface, which then yields the angular correction for each beam to approximate an ideal optical system. For some implementations, light sensors (photodiodes) may be embedded into the SLEA 110 to sense the position of each beam on the retina from the light that is reflected back towards the SLEA (akin to a “red-eye effect”). Adding photodiodes to the SLEA is readily achievable in terms of IC integration capabilities because the pixel-to-pixel distance is large and provides ample room for the photodiode support circuitry. With this embedded array of light sensors, it becomes possible to measure the actual optical properties of the eye and correct for lens aberrations without the need for a prescription from a prior eye examination. This mechanism would work if some light is emitted by the HMD. Depending on how sensitive the photodiodes are, alternate implementations could rely on some minimal background illumination for dark scenes, suspend adaptation when there is insufficient light, use a dedicated adaptation pattern at the beginning of use, and/or add an IR illumination system.

Monitoring the eye precisely measures the inter-eye distance and the actual orientation of the eye in real-time that yields information for improving the precision and fidelity of computer-generated 3D scenes. Indeed, perspective and stereoscopic image pair generation use an estimate of the observer's eye positions, and knowing the actual orientation of each eye may provide a cue to software as to which part of a scene is being observed.

With regard to various implementations disclosed herein, however, it should be noted that the MLA pitch is unrelated to the resulting resolution of the display device because the MLA itself is not positioned in an image plane. Instead, the resolution of this display device is dictated by how precisely the direction of the beams can be controlled and how tightly these beams are collimated.

Smaller LEDs produce higher resolution. For example, a MLA focal length of 2.5 mm and an LED emission aperture of 1.5 micrometers in diameter would yield a geometric beam divergence of 2.06 arc-minutes or about twice the human eye's angular resolution. This would produce a resolution equivalent to an 85 DPI (dots per inch) display at a viewing distance of about 20 inches. Over a 66 degree field of view, this is equivalent to a width of 1920 pixels. In other words, in two-dimensions this configuration would result in a display of almost four million pixels and exceed current high-definition television (HDTV) standards. Based on these parameters, however, the SLEA would have an active area of about 20 mm by 20 mm completely covered with 1.5 micrometer sized light emitters—that is, a total of about 177 million LEDs. However, such a configuration is impractical for several reasons including the fact that there would be no room between LEDs for the needed wiring or drive electronics.

To overcome this, various implementations disclosed herein are directed to “multiplexing” approximately 250,000 LEDs to time sequentially produce the effect of a dense 177 million LED array. For certain alternative implementations, the movement may also be achieved by electro-optical means. This approach exploits both the high efficiency and fast switching speeds featured by solid state LEDs. In general, LED efficiency favors small devices with high current densities resulting in high radiance, which in turn allows the construction of a LED emitter where most light is produced from a small aperture. Red and green LEDs of this kind have been produced for over a decade for fiber-optic applications, and high-efficiency blue LEDs can now be produced with similarly small apertures. A small device size also favors fast switching times due to lower device capacitance, enabling LEDs to turn on and off in a few nanoseconds while small specially-optimized LEDs can achieve sub-nanosecond switching times. Fast switching times allow one LED to time sequentially produce the light for many emitter locations. While the LED emission aperture is small for the proposed display device, the emitter pitch is under no such restriction. Thus, the LED display chip is an array of small emitters with enough room between LEDs to accommodate the drive circuitry.

With regard to the various AR implementations described herein, the light from the sparse iLED array (that comprises the SLEA) is illuminated in bursts over time in conjunction with a moving covering microlens array (or active optical element) such that the color, direction, and intensity can be controlled via current drive at specific time intervals. The motion of the microlens array may be in the hundreds to thousands of cycles per second to enable short high-intensity bursts and thereby allow an entire array image to be produced. The motion (or motion-like effects) of the iLED array effectively multiplies the number of active iLED emitters, thereby increasing the resolution to the level used for a light-field display to produce an eye box (in the 20×20 mm range) for generating an image over the entire pupil of the user's eye. Regardless, movement of the microlens array (and its iLEDs) may be achieved using a variety of methods including but not limited to the utilization of piezoelectric components, electromagnetic coils, microelectromechanical systems (MEMS), and so forth. The same can be said for the movement of a micro-mirror array for such implementations.

Stated differently, in order to achieve the resolution, the LEDs of the display chip are multiplexed to reduce the number of actual LEDs on the chip down to a practical number. At the same time, multiplexing frees chip surface area that is used for the driver electronics and perhaps photodiodes for the sensing functions as discussed earlier. Another reason that favors a sparse emitter array is the ability to accommodate three different, interleaved sets of emitter LEDs, one for each color (red, green, and blue), which may use different technologies or additional devices to convert the emitted wavelength to a particular color. Since iLED arrays generally only produce a single color light, light conversion using color filters, phosphorous material, and/or quantum dots (QDs) may be used to convert a single color other colors.

For certain implementations, each LED emitter may be used to display as many as 721 pixels (a 721:1 multiplexing ratio) so that instead of having to implement 177 million LEDs, the SLEA uses approximately 250,000 LEDs. The factor of 721 is derived from increasing a hexagonal pixel to pixel distance by a factor of 15 (i.e., a 15×pitch ratio, that is, the ratio between the number of points in two hexagonal arrays is 3*n*(n+1)+1 where n is the number of point omitted between the points of the coarser array). Other multiplexing ratios are possible depending on the available technology constraints. Nevertheless, a hexagonal arrangement of pixels seemingly offers the highest possible resolution for a given number of pixels while mitigating aliasing artifacts. Therefore, implementations discussed herein are based on a hexagonal grid, although quadratic or rectangular grids may be used as well and nothing herein is intended to limit the implementations disclosed to only hexagonal grids. Furthermore, it should be noted that the MLA structure and the SLEA structure do not need to use the same pattern. For example, a hexagonal MLA may use a display chip with a square array, and vice versa. Nevertheless, hexagons are seemingly better approximations to a circle and offer improved performance for the MLA.

As an alternative to the mechanical multiplexing described above, alternative implementations may instead use an electrically steerable microlens array. One-dimensional lenticular lens arrays have been demonstrated using liquid crystal material that was subject to a lateral (in plane) electrical field from an interdigital electrode array for the purpose of 3D displays that directs light towards the left and right eye in a time sequential fashion. For such alternative implementations, a stack of two of these structures oriented in perpendicular directions may be used, or a 3D electrode structure that allows a stationary microlens array to be steered in both x and y directions independently may be utilized. Notably, each such structure could be “switched off” by removing the electrical field which, in turn, would render the microlens array inactive and thereby allow a clear view through the display (and by which the time-sequential multiplexing approach discussed earlier herein may be enabled).

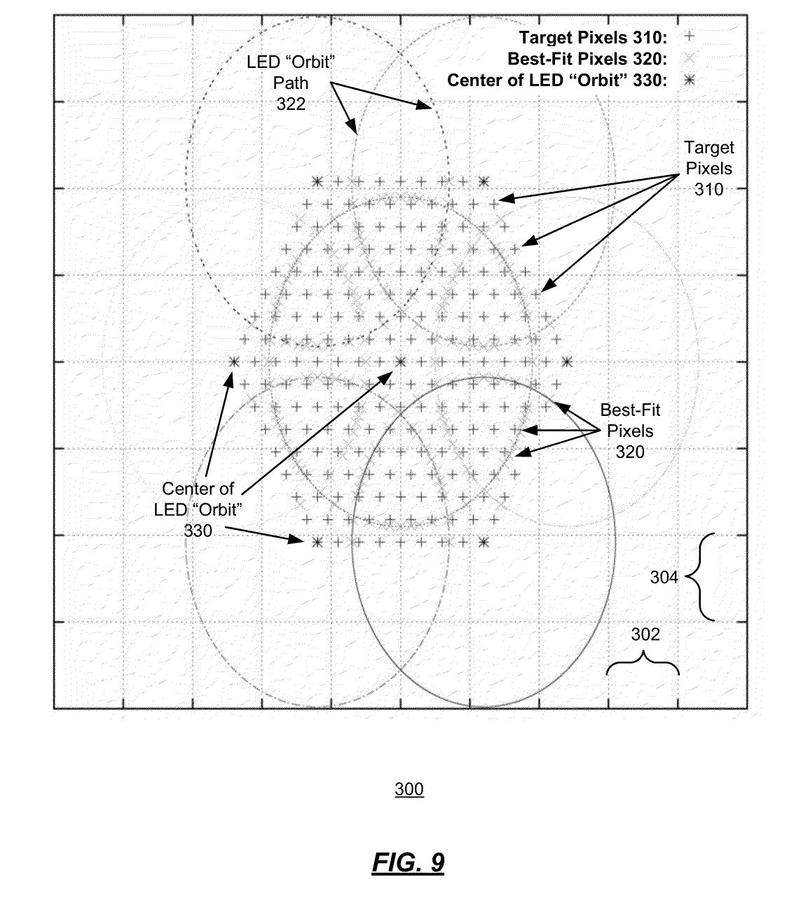

FIG. 9 illustrates an exemplary SLEA geometry for certain implementations disclosed herein. In the figure—and superimposed on a grid featuring increments on the X-axis 302 and the Y-axis 304 are 5 micrometers—the SLEA geometry features an 8×pitch ratio (in contrast to the 15×pitch ratio described above) which corresponds to the distance between two center of LED “orbits” 330 measured as a number of target pixels 310 (i.e., each center of LED orbit 330 is spaced eight target pixels 310 apart). In the figure, the target pixels 310 denoted by a plus sign (“+”) indicate the location of a desired LED emitter on the display chip surface representative of the arrangement of the 177 million LED configuration discussed above. In this exemplary implementation, the distance between each target pixel is 1.5 micrometers (consistent with providing HDTV fidelity, as previously discussed). The stars (similar to “*”) are the center of each LEDs “orbit” 330 (discussed below) and thus represents the presence of an actual physical LED, and the seven LEDs shown are used to simulate the desired LEDs for each target pixel 310. While each LED may emit light from an aperture with a 1.5 micrometer diameter, these LEDs are spaced 12 micrometers apart in the figure (22.5 micrometers apart for the 15×pitch ratio discussed above). Given that contemporary integrated circuit (IC) geometries use 22 nm to 45 nm transistors, this provides sufficient spacing between the LEDs for circuits and other wiring.

In such implementations represented by the configuration of FIG. 9, the SLEA and the MLA are moved with respect to each other to effect an “orbit” for each actual LED. In certain specific implementations, this is done by moving the SLEA, moving the MLA, or moving both simultaneously. Regardless of implementation, the displacement for the movement is small—on the order of about 30 micrometers—which is less than the diameter of a human hair. Moreover, the available time for one scan cycle is about the same as one frame time for a conventional display, that is, a one hundred frames-per-second display will use one hundred scan-cycles-per-second. This is readily achievable since moving an object with a weight of a fractional gram a distance of less than the diameter of a human hair one hundred times per second does not use much energy and can be done using either piezoelectric or electromagnetic actuators for example. For certain implementations, capacitive or optical sensors can be used in the drive system to stabilize this motion. Moreover, since the motion is strictly periodic and independent of the displayed image content, an actuator may use a resonant system which saves power and avoids vibration and noise. In addition, while there may be a variety of mechanical, electro-mechanical, and electro-optical methodologies for moving the array of various implementations described herein, alternative implementations that employ a liquid crystal matrix (LCM) between the SLEA and MLA to provide motion are also contemplated and hereby disclosed.

FIG. 9 further illustrates the multiplexing operation using a circular scan trajectory represented by the circles labeled as LED “orbit” paths 322. For such implementations, the actual LED's are illuminated during their orbits when they are closest to the desired position—shown by the best-fit pixels 320 “X”-symbols in the figure—of the target pixels 310 that the LED is supposed to render. While the approximation is not particularly good in this particular configuration (as is evident by the fact that many “X” symbols are a bit far from the “+” target pixels 310 locations), the approximation improves with increases to the diameter of the scan trajectory.

When calculating the mean and maximal position error for a 15×pitch configuration as a function of the magnitude of mechanical displacement, it becomes evident that a circular scan path is not optimal. Instead, a Lissajous curve—which is generated if the sinusoidal deflection in the x and y direction occur with different frequencies—seemingly offers a greatly reduced error, and thus sinusoidal deflection is often chosen because it arises naturally from a resonant system. For example, the SLEA may be mounted on an elastic flex stage (e.g., a tuning fork) that moves in the X-direction while the MLA is attached to a similar elastic flex stage that moves in the perpendicular Y-direction. For a 3:5 frequency ratio, which in the context of a one hundred frames-per-second system, the stages operate at 300 Hz and 500 Hz (or any multiple thereof). Indeed, these frequencies are practical for a system that only uses deflection of a few sub-micrometers as the 3:5 Lissajous trajectory would have a worst case position error of 0.97 micrometers and a mean position error of only 0.35 micrometers when operated with a deflection of 34 micrometers.

Alternative implementations may utilize variations on how the scan movement could be implemented. For example, for certain implementations, an approach would be to rotate the MLA in front of the display chip. Such an approach has the property that the angular resolution increases along the radius extending outward from the center of rotation, which is helpful because the outer beams benefit more from higher resolution.

It should also be noted that solid state LEDs are among the most efficient light sources today, especially for small high-current-density devices where cooling is not a problem because the total light output is not large. An LED with an emitting area equivalent to the various SLEA implementations described herein could easily blind the eye at a mere 15 mm distance in front of the pupil if it were fully powered (even without focusing optics), and thus only low-power light emissions are used. Moreover, since the MLA will focus a large portion of the LED's emitted light directly into the pupil, the LEDs use even less current than normal. In addition, the LEDs are turned on for very short pulses to achieve what the user will perceive as a bright display. Decreasing the overall display brightness prevents contraction of the pupil which would otherwise increase the depth of field of the eye and thereby reduce the effectiveness of optical depth cues. Instead, various implementations disclosed herein use a range of relatively low light intensities to increase the “dynamic range” of the display to show both very bright and very dark objects in the same scene.

The acceptance of HMDs has been limited by their tendency to induce motion sickness, a problem that is commonly attributed to the fact that visual cues are constantly integrated by the human brain with the signals from the proprioceptive and the vestibular systems to determine body position and maintain balance. Thus, when the visual cues diverge from the sensation of the inner ear and body movement, users become uncomfortable. This problem has been recognized in the field for over 20 years, but there is no consensus on how much lag can be tolerated. Experiments have shown that a 60 milliseconds latency is too high, and a lower bound has not yet been established because most currently available HMDs still have latencies higher than 60 milliseconds due to the time needed by the image generation pipeline using available display technology.

Nevertheless, various implementations disclosed herein overcome this shortcoming due to the greatly enhanced speed of the LED display and faster update rate. This enables attitude sensors in the HMD to determine the user's head position in less than 1 millisecond, and this attitude data may then be used to update the image generation algorithm accordingly. In addition, the proposed display may be updated by scanning the LED display such that changes are made simultaneously over the visual field without any persistence, an approach different from other display technologies. For example, while pixels continuously emit light in a LCOS display, their intensity is adjusted periodically in a scan-line fashion which gives rise to tearing artifacts for fast moving scenes. In contrast, various implementations disclosed herein feature fast (and for certain implementations frameless) random update of the display. As known and appreciation by those skilled in the art, frameless rendering reduces motion artifacts, which in conjunction with a low latency position update could mitigate the onset of virtual reality sickness.

Several implementation may be directed to a system comprising an interactive head-mounted eyepiece worn by a user, wherein the eyepiece includes an optical assembly through which the user views the surrounding environment and displayed content, wherein the optical assembly comprises (a) a corrective element that corrects the user's view of the surrounding environment, (b) an integrated processor for handling content for display to the user, and (c) an integrated image source for introducing the content to the optical assembly. Certain of these implementations may also comprise an interactive control element. For certain implementations, the eyepiece may also include an adjustable wrap around extendable arm comprising any shape memory material for securing the position of the eyepiece to the user's head. For several implementations, the integrated image source that introduces the content to the optical assembly may be configured such that the displayed content aspect ratio is, from the user's perspective, between approximately square to approximately rectangular with the long axis approximately horizontal.

For several implementations, an apparatus for biometric data capture may also be utilized wherein the biometric data to be captured may comprise visual biometric data such as iris biometric data, facial biometric data, and/or audio biometric data. For certain such implementations, visual-based biometric data capture may be accomplished with an integrated optical sensor assembly while audio-based biometric data capture may be accomplished using an integrated microphone array. For some implementations, the processing of the captured biometric data may occur locally while in other implementations the processing of the captured biometric data may occur remotely and, for these latter implementations, data may be transmitted using an integrated communications facility. For such implementations, a local or remote computing facility may be used (respectively) to interpret and analyze the captured biometric data, generate display content based on the captured biometric data, and deliver the display content to the eyepiece. For certain such implementations featuring biometric data capture, a camera may be mounted on the eyepiece for obtaining biometric images of the user proximate to the eyepiece.

Since individual LEDs (including iLEDs) are generally monochromatic but do exist in each of the three primary colors, each of these LEDs 114, 116, and 118 may correspond to three different colors, for example, red, green, and blue respectively, and these colors may be emitted in differing intensities to blend together at the pixel 140 to create any resultant color desired. Alternatively, other implementations may use multiple LED arrays that have specific red, green, and blue arrays that would be placed under, for example, four SLA (2×2) elements. In this configuration, the outputs would be combined at the eye to provide color at, for example, the 1 mm level versus the 10 ˜m level produced within the LED array. As such, this approach may save on sub-pixel count and reduce color conversion complexity for such implementations. For certain implementations, the SLEA may not necessarily comprise RGB LEDs because, for example, red LEDs use a different manufacturing process; thus, certain implementations may comprise a SLEA that includes only blue LEDs where green and red light is produced from blue light via conversion, for example, using a layer of fluorescent material such as quantum dots (QDs).

More specifically, and for various implementations disclosed herein, the projection optics (or “projector”) may comprise a red-green-blue (RGB) iLED configuration to produce field sequential color. With field sequential color, a single full color image may be broken down into color fields based on the primary colors of red, green, and blue and imaged by a liquid crystal on silicon (LCoS) optical display individually. As each color field is imaged by the optical display, the corresponding LED color is turned on. When these color fields are displayed in rapid sequence, a full color image may be seen. With field sequential color illumination, the resulting projected image can be adjusted for any chromatic aberrations by shifting the red image relative to the blue and/or green image and so on.

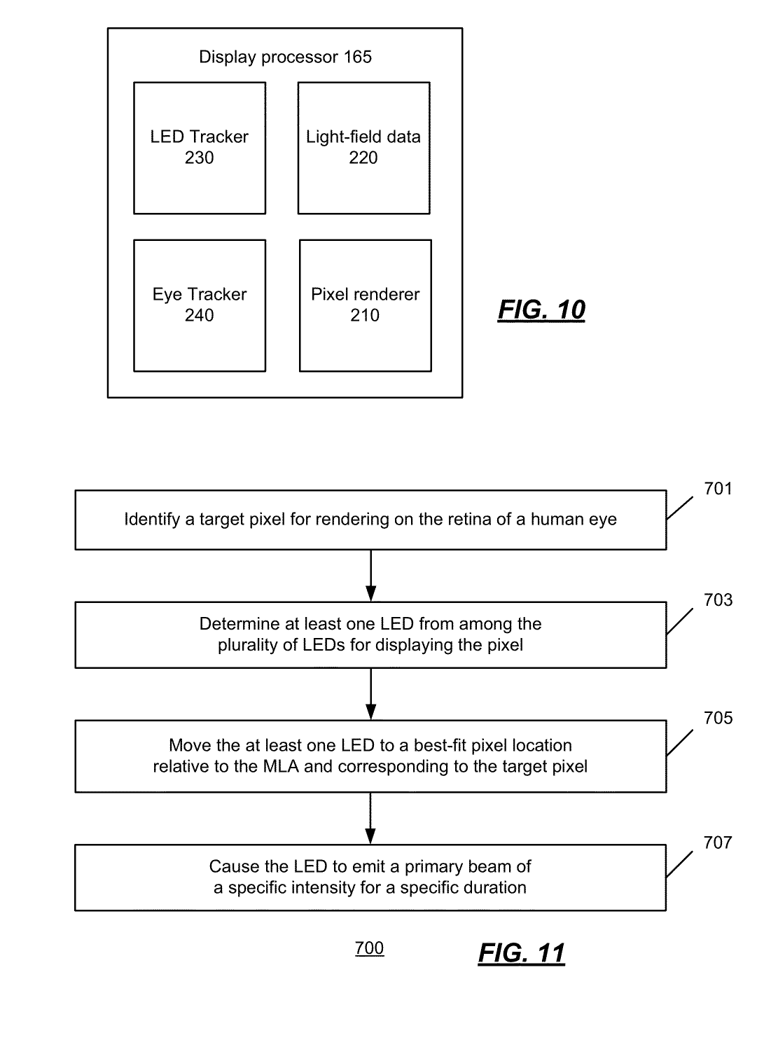

FIG. 10 is a block diagram of an implementation of a display processor 165 that may be utilized by the various implementations described herein. A display processor 165 may track the location of the in-motion LED apertures in the LFP 100 (or LFP 100′), the location for each microlens in the MLA 120 (or MMA 120′), adjust the output of the LEDs comprising the SLEA, and process data for rendering the light-field. The light-field may be a 3D image or scene, for example, and the image or scene may be part of a 3D video such as a 3D movie or television broadcast. A variety of sources may provide the light-field to the display processor 165. The display processor 165 may track and/or determine the location of the LED apertures in the LFP 100. In some implementations, the display processor 165 may also track the location of the aperture formed by the iris 136 of the eyes 130 using location and/or tracking devices associated with the eye tracking. Any system, method, or technique known in the art for determining a location may be used. Moreover, the use of eye tracking and image control enables the system to selectively illuminate only that portion of the eye box that can actually be seen by the eye of the user, thereby reducing power consumption. By using a direct emitting approach (similar to that used for organic LEDs or OLEDs), only the pixels that need to be drawn are driven at the appropriate intensity to provide high contrast (with higher intensity) while using only low power consumption. In any event, the use of eye tracking to only turn on portions of the iLED array based on position of the eye uses lower power such as when implemented using sensing pixels to drive the iLED array for purposes of this eye tracking.

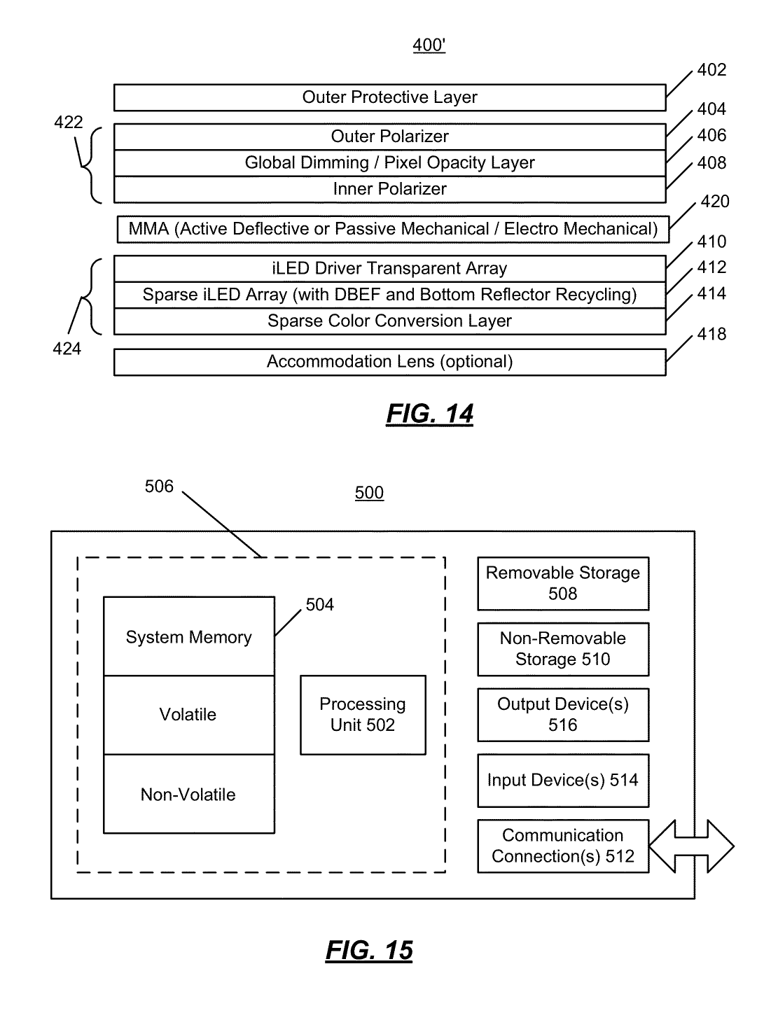

The display processor 165 may be implemented using a computing device such as the computing device 500 described with respect to FIG. 15. The display processor 165 may include a variety of components including an eye tracker 240. The display processor 165 may further include an LED tracker 230 as previously described. The display processor 165 may also comprise light-field data 220 that may include a geometric description of a 3D image or scene for the LFP 100 to display to the eyes of a user. In some implementations, the light-field data 220 may be a stored or recorded 3D image or video. In other implementations, the light-field data 220 may be the output of a computer, video game system, or set-top box, etc. For example, the light-field data 220 may be received from a video game system outputting data describing a 3D scene. In another example, the light-field data 220 may be the output of a 3D video player processing a 3D movie or 3D television broadcast.

The display processor 165 may comprise a pixel renderer 210. The pixel renderer 210 may control the output of the LEDs so that a light-field described by the light-field data 220 is displayed to a viewer of the LFP 100. The pixel renderer 210 may use the output of the LED tracker 230 (i.e., the pixels that are visible through each individual microlens of the MLA 120 at the viewing apertures 140a and 140b) and the light-field data 220 to determine the output of the LEDs that will result in the light-field data 220 being correctly rendered to a viewer of the LFP 100. For example, the pixel renderer 210 may determine the appropriate position and intensity for each of the LEDs to render a light-field corresponding to the light-field data 220. For example, for opaque scene objects, the color and intensity of a pixel may be determined by the pixel renderer 210 by determining by the color and intensity of the scene geometry at the intersection point nearest the target pixel. Computing this color and intensity may be done using a variety of known techniques.

In some implementations, the pixel renderer 210 may stimulate focus cues in the pixel rendering of the light-field. For example, the pixel renderer 210 may render the light-field data to include focus cues such as accommodation and the gradient of retinal blur appropriate for the light-field based on the geometry of the light-field (e.g., the distances of the various objects in the light-field) and the display distance 112. Any system, method, or techniques known in the art for stimulating focus cues may be used.

FIG. 11 is an operational flow diagram 700 for utilization of a LFP by the display processor 165 of FIG. 10 in an HMD representative of various implementations described herein. At 701, the display process 165 identifies a target pixel for rendering on the retina of a human eye. At 703, the display process determines at least one LED from among the plurality of LEDs for displaying the pixel. At 705, the display processor moves the at least one LED to a best-fit pixel 320 location relative to the MLA and corresponding to the target pixel and, at 707, the display process causes the LED to emit a primary beam of a specific intensity for a specific duration.

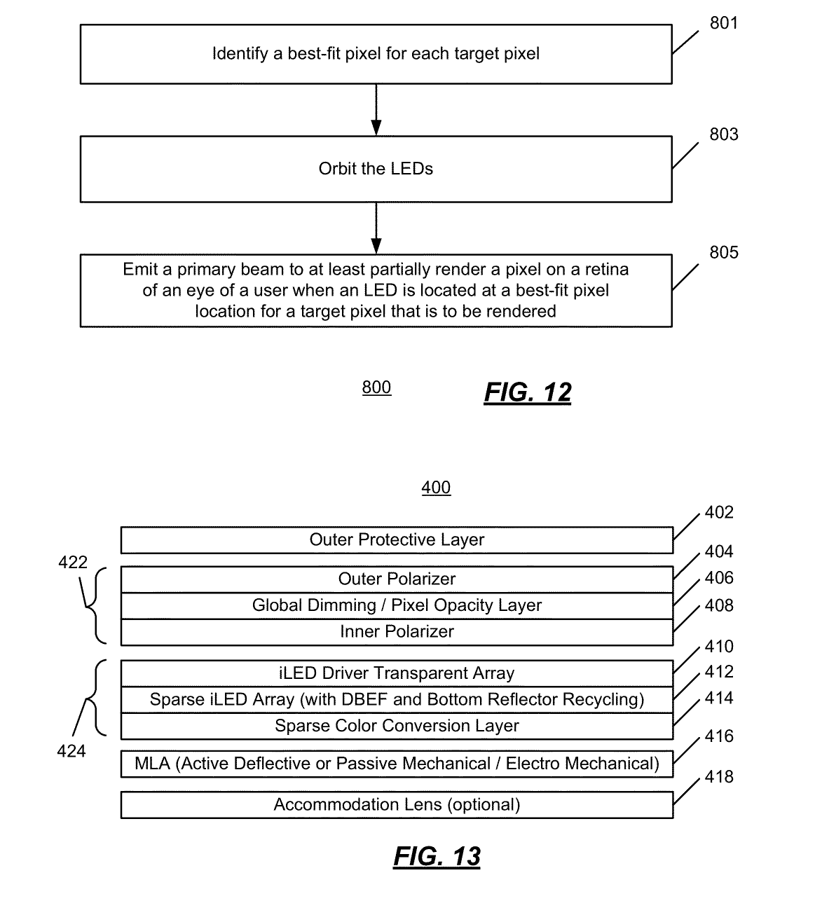

FIG. 12 is an operational flow diagram 800 for the mechanical multiplexing of a LFP by the display processor 165 of FIG. 10. At 801, the display processor 165 identifies a best-fit pixel for each target pixel. At 803, the processor orbits the LEDs and, at 805, emits a primary beam to at least partially render a pixel on a retina of an eye of a user when an LED is located at a best-fit pixel location for a target pixel that is to be rendered.

FIG. 13 is a block diagram of a stack structure for a low-power, high-resolution, see-through display representative of one MLA-based implementation (i.e., using a microlens array corresponding to FIGS. 1-4) of the AR solution using an HMD architecture resembling a pair of eyeglasses disclosed herein. In FIG. 13, the display 400 comprises a transparent outer protective layer 402 furthest from the eye that, in turn, is coupled to a polarizer component 422 comprising an outer polarizer 404, a global dimming/pixel opacity layer 406, and an inner polarizer 408. The polarizer component 422 is coupled to SLEA 424 (corresponding to SLEA 110) comprising an iLED driver transparent array 410, a sparse iLED array 412 with DBEF and bottom reflector recycling, and a sparse color conversion layer 414 implementing one of the color conversion approaches described earlier herein. The SLEA 424, in turn, is operatively coupled to the MLA 416 (corresponding to MLA 120) that is either active deflective or one of passive mechanical or electro mechanical. An optional accommodation lens 418 is coupled to the inside of the assembly (closest to the eye) to provide vision correction for the user in this particular implementation. In an alternative implementation, the accommodation lens 418 may instead be located outside of (or in lieu of) the outer protective layer 402. For certain such implementations, the entire display 400 may be formed of transparent materials to resemble the lens (or lenses) in a pair of glasses (sunglasses or eyeglasses) accordingly. Moreover, for certain alternative implementations, the polarizers and/or dimming layer may not be present, and several of the other components may also be deemed to be optional.

Similar to FIG. 13, FIG. 14 is a block diagram of a stack structure for a low-power, high-resolution, see-through display representative of one MMA-based implementation (i.e., using a micro-mirror array corresponding to FIGS. 5-8) of the AR solution using an HMD architecture resembling a pair of eyeglasses disclosed herein. In FIG. 14, the display 400′ comprises a transparent outer protective layer 402 furthest from the eye that, in turn, is coupled to a polarizer component 422 comprising an outer polarizer 404, a global dimming/pixel opacity layer 406, and an inner polarizer 408. The polarizer component 422 is coupled to the MMA 420 (corresponding to MMA 120′) that is either active deflective or one of passive mechanical or electro mechanical. The MMA 420, in turn, is operatively coupled to SLEA 424 (corresponding to SLEA 110) comprising an iLED driver transparent array 410, a sparse iLED array 412 with DBEF and bottom reflector recycling, and a sparse color conversion layer 414 implementing one of the color conversion approaches described earlier herein. An optional accommodation lens 418 is coupled to the inside of the assembly (closest to the eye) to provide vision correction for the user in this particular implementation. In an alternative implementation, the accommodation lens 418 may instead be located outside of (or in lieu of) the outer protective layer 402. For certain such implementations, the entire display 400 may be formed of transparent materials to resemble the lens (or lenses) in a pair of glasses (sunglasses or eyeglasses) accordingly.

It should be noted that while the concepts and solutions presented herein have been described in the context of use with an HMD, other alternative implementations are also contemplated such as for general use in projection solutions. For example, various implementations described herein may be used to increase the resolution of a display system having smaller MLA (i.e., lens) to SLEA (i.e., LED) ratios. In one such implementation, an 8×by 8×solution could be achieved using smaller MLA elements (on the order of 10 um to 50 μm in contrast to 1 mm) where the motion of the array allows greater resolution. Certain benefits of such implementations may be lost (such as focus) while providing other benefits (such as increased resolution). In addition, alternative implementations might also project the results of an electrically moved array into a light guide solution to enable augmented reality applications. Furthermore, although implementations have herein been described with regard to augmented reality (AR) applications, nothing herein is intended to exclude virtual reality (VR) applications, and any reference to an AR application made herein includes reference to a corresponding VR application. For such VR applications, moreover, it will be readily apparent to skilled artisans that the MMA (for MMA-based implementations) or the SLEA (for MLA-based implementations) need not be transparent. The technologies described herein may also be readily applied to transparent and non-transparent displays of various kinds such as computer monitors, televisions, and integrated transparent displays in a variety of different applications and products.

FIG. 15 is a block diagram of an example computing environment that may be used in conjunction with example implementations and aspects. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 15, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 15 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 15 by removable storage 508 and non-removable storage 510.

Computing device 500 typically includes a variety of computer readable media. Computer readable media can be any available media that can be accessed by device 500 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the information and which can be accessed by computing device 500. Any such computer storage media may be part of computing device 500.

Computing device 500 may contain communication connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well-known in the art and need not be discussed at length here.

Computing device 500 may be one of a plurality of computing devices 500 inter-connected by a network. As may be appreciated, the network may be any appropriate network, each computing device 500 may be connected thereto by way of communication connection(s) 512 in any appropriate manner, and each computing device 500 may communicate with one or more of the other computing devices 500 in the network in any appropriate manner. For example, the network may be a wired or wireless network within an organization or home or the like, and may include a direct or indirect coupling to an external network such as the Internet or the like.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an API, reusable controls, or the like. Such programs may be implemented in a high level procedural or object-oriented programming language to communicate with a computer system. However, the program(s) can be implemented in assembly or machine language. In any case, the language may be a compiled or interpreted language and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A transparent light-field projector (LFP) device for providing an augmented reality display, the device comprising:
a transparent solid-state LED array (SLEA) comprising a plurality of integrated light-emitting diodes (iLEDs);
a micro-array (MA) placed at a separation distance from the SLEA, the MA comprising a plurality of either microlenses or micro-mirrors; and
a processor communicatively coupled to the SLEA and adapted to:
identify a target pixel for rendering on the retina of a human eye,
determine at least one iLED from among the plurality of iLEDs for displaying the pixel,
move the at least one iLED to a best-fit pixel location relative to the MA and corresponding to the target pixel, and
cause the iLED to emit a primary beam of a specific intensity for a specific duration.

2. The device of claim 1, wherein the iLEDs comprising the SLEA utilize a random pattern arrangement for a spacing offset between iLEDs in the iLED array.

3. The device of claim 1, wherein the MA utilizes at least one from among the group comprising a time-domain multiplexing, a wavelength multiplexing, and a polarization multiplexing.

4. The device of claim 1, wherein the SLEA only emits light in a limited range of the visible spectrum and the MA only distorts light in the limited range of the visible spectrum and does not distort light that is not in the limited range of the visible spectrum.

5. The device of claim 1, further comprising a polarizer component, wherein real world light passing through the device is polarized in a first direction and iLED-emitted light is polarized in a second direction opposite the first direction.

6. The device of claim 5, where the polarizer component utilizes a Dual Brightness Enhancement Film (DBEF).

7. The device of claim 1, further adapted to correct for imperfect vision of a user of the LFP.

8. The device of claim 1, wherein a diameter and a focal length of each microlens among the plurality of either microlenses or micro-mirrors comprising the MA is sized to permit no more than one beam from each LED comprising the SLEA to enter the human eye.

9. The device of claim 1, wherein a pixel projected onto the retina of the human eye comprises primary beams from multiple LEDs from among the plurality of LEDs.

10. The device of claim 1, wherein the plurality of LEDs are multiplexed to time-sequentially produce an effect of a larger number of static LEDs.

11. The device of claim 1, wherein the separation distance is equal to a focal length for a corresponding microlens in the MA to enable the MA to collimate light emitted from the SLEA.

12. The device of claim 1, wherein the processor is further adapted to add focus cues to a generated light field.

13. A method for multiplexing a plurality of integrated light-emitting diodes (iLEDs) in a light-field projector (LFP) comprising a transparent solid-state LED array (SLEA) having a plurality of iLEDs and a micro-array (MA) having a plurality of either microlenses or micro-mirrors placed at a separation distance from the SLEA, the method comprising:
arranging a plurality of iLEDs to achieve overlapping orbits;
identifying a best-fit pixel for each target pixel;
orbiting the iLEDs; and
emitting a primary beam to at least partially render a pixel on a retina of an eye of a user when an LED is located at a best-fit pixel location for a target pixel that is to be rendered.

14. The method of claim 13, wherein the MA and the SLEA use the same pattern.

15. The method of claim 13, wherein the arranging results in a hexagonal arrangement of the plurality of iLEDs.

16. The method of claim 13, wherein the arranging is performed to achieve a 15×pitch ratio to achieve a 721:1 multiplexing ratio.

17. The method of claim 13, wherein the orbiting follows a 3:5 Lissajous trajectory.

18. A computer-readable medium comprising computer-readable instructions for a light-field projector (LFP) comprising a transparent solid-state LED array (SLEA) having a plurality of integrated light-emitting diodes (iLEDs) and a micro-array (MA) having a plurality of either microlenses or micro-mirrors placed at a separation distance from the SLEA, the computer-readable instructions comprising instructions that cause a processor to:
identify a plurality of target pixels for rendering on the retina of a human eye,
calculate the subset of iLEDs from among the plurality of iLEDs to be used for displaying the pixel,
multiplexing the plurality of iLEDs, and
cause each iLED among the subset of iLEDs to emit a primary beam of a specific intensity for a specific duration in accordance with best-fit pixel location relative to the MA and corresponding to the target pixel.

19. The computer-readable medium of claim 18, further comprising instructions for causing the processor to add finite focus cues to the rendered image.

20. The computer-readable medium of claim 18, further comprising instructions for sensing the position of each rendered beam on the retina of the eye from the light that is reflected back towards the SLEA.
